(19) United States
(12) Patent Application Publication
(10) Pub. No.: US 2019/0305615 A1
(43) Pub. Date: Oct. 3, 2019

(54) STATOR FRAME, STATOR, AND ROTARY ELECTRIC MACHINE

(71) Applicant: FANUC CORPORATION, Yamanashi (JP)

(72) Inventor: Yasuo YAMADA, Yamanashi (JP)

(73) Assignee: FANUC CORPORATION, Yamanashi (JP)

(21) Appl. No.: 16/356,871

(22) Filed: Mar. 18, 2019

(30) Foreign Application Priority Data
Mar. 29, 2018 (JP) 2018-063611

(51) Int. Cl. H02K 1/20

(52) U.S. Cl. CPC H02K 1/20

(57) ABSTRACT

A stator frame has a substantially cylindrical shape and includes a function of cooling a stator of a rotary electric machine, the stator frame including a cooling groove provided along a circumferential direction of an outer circumferential surface in between one end side and another end side in an axis direction as a flow path of a refrigerant in an outer circumferential surface of the stator frame. In a section of the stator frame cut in a plain surface including an axis of the stator frame, a surface length of the cooling groove per a unit section region at one end side and another end side in the axis direction is longer than a surface length of the cooling groove per a unit section region at a vicinity of a center in the axis direction.

This application is based on and claims the benefit of priority from Japanese Patent Application No. 2018-063611, filed on 29 Mar. 2018, the content of which is incorporated herein by reference.

### BACKGROUND OF THE INVENTION

### Field of the Invention

The present invention relates to a stator frame, a stator, and a rotary electric machine.

### Related Art

In a rotary electric machine (a motor or the like) including a rotor and a stator, the stator includes an iron core to which a winding is inserted, and a stator frame mounted in the outer circumferential surface of the iron core. When a rotary electric machine is driven, heat is generated in a stator or the like due to heat loss such as iron loss. Thus, a structure has been adopted, the structure provided with a flow path through which a refrigerant flows, in between a stator frame and a housing fit to the outside of the stator frame for cooling a stator (see, for example, Patent Document 1).

Patent Document 1: Japanese Unexamined Patent Application, Publication No. 2011-15578

### SUMMARY OF THE INVENTION

In the rotary electric machine described above, a groove is formed in the outer circumferential surface of the stator frame. When a housing having a substantially cylindrical shape is fit to the outside of the stator frame, an opening of the groove provided in the outer circumferential surface of the stator frame is blocked by the inner circumferential surface of the housing. As a result, a flow path through which a refrigerant can flow is formed between the outer circumferential surface of the stator (stator frame) and the inner circumferential surface of the housing. However, in conventional rotary electric machines, both end portions of a winding in an axis direction is separated not only from an iron core, but also from a flow path. Thus, in conventional rotary electric machines, there has been a problem that heat generated in both end portions of a winding is hard to be dissipated.

An object of the present invention is to provide a stator frame, a stator, and a rotary electric machine excellent in heat dissipation properties.

(1) The present invention relates to a stator frame (for example, a stator frame 22 described later) having a substantially cylindrical shape and including a function of cooling a stator (for example, a stator 20 described later) of a rotary electric machine, the stator frame including a cooling groove (for example, a cooling groove 230 described later) provided along a circumferential direction of an outer circumferential surface in between one end side and another end side in an axis direction (for example, an X direction described later) as a flow path (for example, a flow path 23 described later) of a refrigerant in the outer circumferential surface of the stator frame, in which, in a section of the stator frame cut in a plain surface including an axis (for example, a rotary axis line S described later) of the stator frame, a surface length or the cooling groove per a unit section region (for example, a unit section region S1 described later) at one end side and another end side in the axis direction is longer than a surface length of the cooling groove per a unit section region (for example, a unit section region S2 described later) at a vicinity of a center in the axis direction.

(2) In the stator frame of (1), in the cooling groove in the section of the stator frame, a groove width (for example, a groove width W described later) in between one end side and another end side in the axis direction may be uniform, and a groove pitch (for example, a groove pitch P1 described later) in regions at one end side and another end side in the axis direction may be narrower than a groove pitch (for example, a groove pitch P2 described later) in a region at a vicinity of a center in the axis direction.

(3) In the stator frame of (1), in the cooling groove in the section of the stator frame, a groove pitch (for example, a groove pitch P1 described later) in one end side and another end side in the axis direction may narrower than a groove pitch (for example, a groove pitch P2 described later) in a region at a vicinity of a center in the axis direction, and a groove width (for example, a groove width W1 described later) in regions at one end side and another end side in the axis direction may be narrower than a groove width (for example, a groove width W2 described later) in a region at a vicinity of a center in the axis direction.

(4) In the stator frame of (1), in the cooling groove in the section of the stator frame, a groove depth (for example, a groove depth D1 described later) regions at one end side and another end side in the axis direction may be deeper than a groove depth (for example, a groove depth D2 described later) in a region at a vicinity of a center in the axis direction.

(5) The present invention relates to a stator (for example, a stator 20 described later) including the stator frame of any of (1) to (4), and an iron core (for example, an iron core 21 described later) having a substantially cylindrical shape and provided at an inner circumferential side of the stator frame.

(6) The present invention relates to a rotary electric machine (for example, a motor 1 described later) including the stator of (5) and a rotor (for example, a rotor 30 described later) supported by a rotary axis (for example, a rotary axis 32 described later) and provided at an inner circumferential side of the stator.

According to the present invention, a stator frame, a stator, and a rotary electric machine excellent in heat dissipation properties can be provided.

### BRIEF DESCRIPTION OF THE DRAWINGS

FIG. 1 is a cross-sectional view showing a configuration of a motor 1 of a first embodiment.

FIG. 2 is a conceptual diagram showing a shape of a cooling groove 230 formed in a stator frame 22 of the first embodiment.

FIG. 3A is a cross-sectional view corresponding to a unit section region S1 of FIG. 2.

FIG. 3B is a cross-sectional view corresponding to a unit section region S2 of FIG. 2.

FIG. 4 is a conceptual diagram showing an end portion in an axis direction of a stator 20.

FIG. 5 is a conceptual diagram showing a shape of a cooling groove 230 formed in a stator frame 222 of a second embodiment.

FIG. 6A is a conceptual diagram showing a shape of the cooling groove 230 formed in a stator frame 322 of a sixth embodiment.

FIG. 6B is an enlarged diagram corresponding to a region S3 of FIG. 6A.

### DETAILED DESCRIPTION OF THE INVENTION

Hereinafter, embodiments of the present invention will be described. Note that all of the diagrams attached herein are schematic diagrams, and shape, scale, vertical and horizontal dimensional ratio, and the like of each part are changed or exaggerated from an actual object for easy understanding. In the diagrams, hatching indicating a section of a member or the like is omitted as appropriate.

In this specification or the like, terms specifying shape, geological conditions, and degrees of these, for example, terms such as “orthogonal” or “direction”, include, in addition to the strict meaning of the terms, a range of a degree that is considered as substantially orthogonal or the like, and a range that is considered as substantially the direction. A line that is a rotation center of a rotary axis 32 described later is referred to as “rotary axis line S”, and a direction along the rotary axis line S is also referred to as “axis direction”. The rotary axis line S of the rotary axis 32 coincides with a center axis of stator frame 22 (described later).

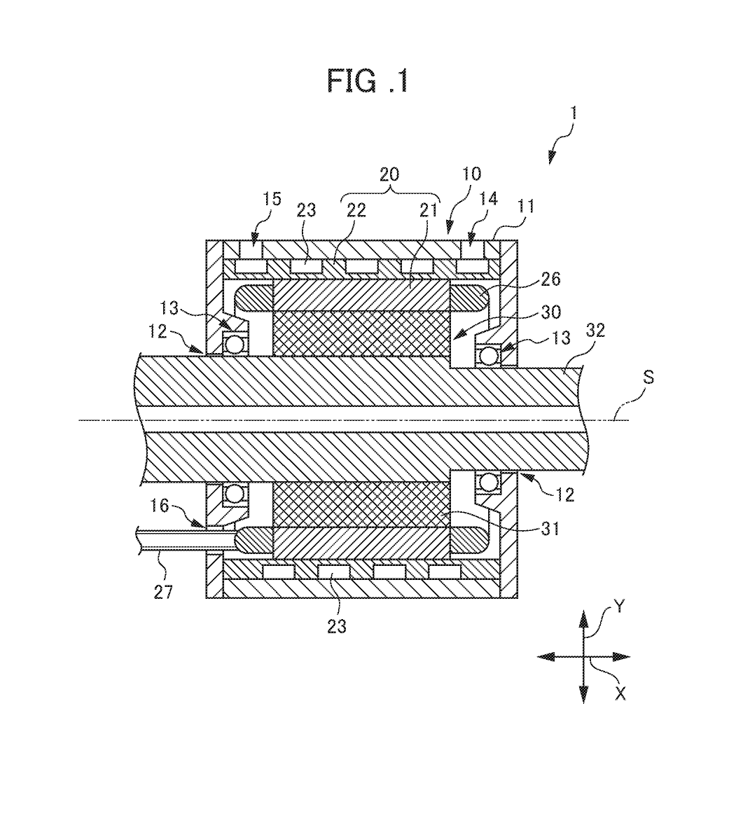

In embodiments, in diagrams such as FIG. 1, a coordinate system in which X and Y are orthogonal to each other is described. In this coordinate system, an axis direction of the motor 1 is an X direction, and a radial direction is a Y direction. The axis direction and radial direction of the motor 1 also coincide with axis directions and radial directions of a stator 20, an iron core 21, and a stator frame 22 described later.

### FIRST EMBODIMENT

First, a motor 1 (rotary electric machine) including, a stator frame 22 of a first embodiment will be described. A basic configuration of the motor 1 in the first embodiment is the same as those in second and third embodiments described later. FIG. 1 is a cross-sectional view showing a configuration of the motor 1 of the first embodiment. Note that the configuration of the motor 1 shown in FIG. 1 is an example, and the motor 1 may have any configuration as long as a stator frame according to the present invention can be applied to the configuration.

As shown in FIG. 1, the motor 1 includes a frame 10, a stator 20, a rotor 30, rotary axis 32, and a bearing 13. The frame 10 is an exterior member of the motor 1, and includes a frame body 11 and an axis hole 12. The frame body 11 is casing enclosing and holding the stator 20. The frame body 11 holds the rotor 30 via the bearing 13. The frame 11 includes a supply port 14, a discharge port 15, and a hole portion 16.

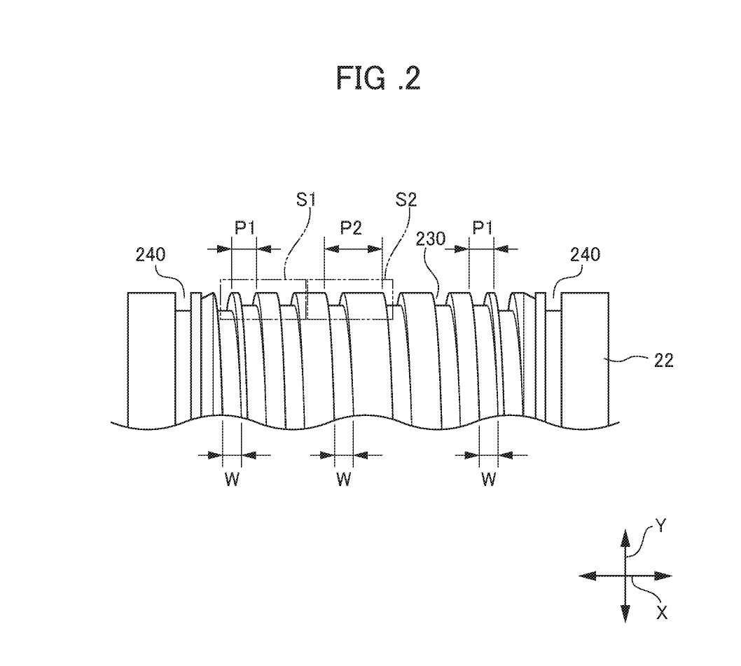

The supply port 14 is a hole for supplying a refrigerant to a flow path 23 (described later) of the stator frame 22. An opening on the outside of the supply port 14 is connected to a supply piping (not shown) of the refrigerant. An opening in the inside of the supply port 14 communicates with an annular groove 240 (see FIG. 2) formed in the stator frame 22. The discharge port 15 is a hole for discharging the refrigerant flowing through the flow path 23. The opening on the outside of the discharge port 15 is connected to a discharge piping (not shown) of the refrigerant. The opening in the inside of the discharge port 15 communicates with the annular groove 240 formed in the stator frame 22.

The hole portion 16 is an opening through which a power line 27 drawn from the stator 20 passes. The axis hole 12 is a hole through which a rotary axis 32 (described later) passes. The stator 20 is a composite member that forms a rotary magnetic field for rotating the rotor 30. The stator 20 is formed to be a cylindrical shape as a whole, and is fixed to the inside of the frame 10. The stator 20 includes the iron core 21 and the stator frame 22.

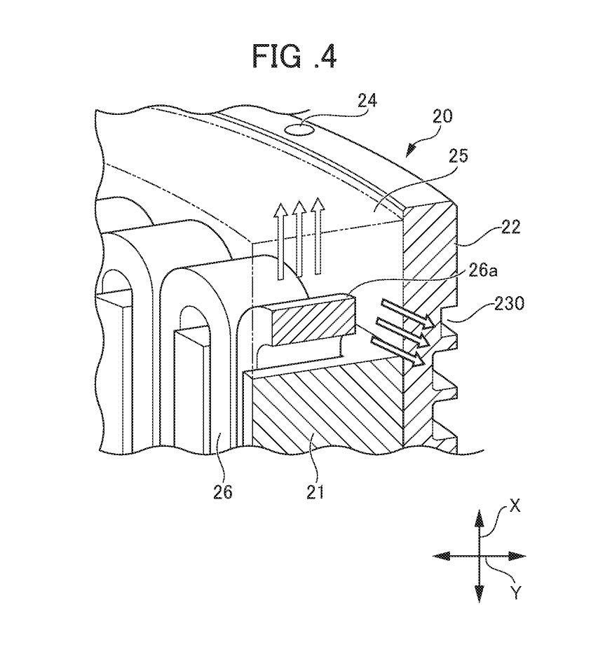

The iron core 21 is a member having an inside to which the winding 26 can inserted. The iron core 21 is formed to be a cylindrical shape, and is arranged in the inside of the stator 20. The iron core 21 is formed with a plurality of grooves (not shown) in the inside surface, and the winding 26 is inserted to these grooves. A part of the winding 26 projects from both end portions of the iron core 21 in an axis direction (X direction) of the iron core 21. The iron core 21 is manufactured, for example, by layering a plurality of thin plates such as an electrical steel plate to form a laminate, bonging the laminate, and integrating the laminate by caulking or the like. The iron core 21 is bonded firmly with the stator frame 22 so as to accept counterforce generated by a torque of the rotor 30. Note that, although not shown in FIG. 1, molds 25 formed of a resin are provided at both end portions in the axis direction of the iron core 21 to which the winding 26 is inserted (see FIG. 4). The molds 25 are provided for protecting the iron core 21 and the winding 26.

The stator frame 22 is a member holding the iron core 21 in the inside. The stator frame 22 is formed to be a substantially cylindrical shape, and is arranged on the outside of a radial direction (Y direction) of the stator 20. The stator frame 22 includes a cooling groove 230 in the outer circumferential surface. The cooling groove 230 is a groove formed along the circumferential direction of the outer circumferential surface of the stator frame 22 from one end side to another end side in the axis direction (X direction).

The cooling groove 230 of the present embodiment is a line of a spiral groove formed in the outer circumferential surface of the stator frame 22. As shown in FIG. 1, when the frame body 11 is fit to the outside of the stator frame 22, the opening of the cooling groove 230 formed in the outer circumferential surface of the stator frame 22 is blocked by the inner circumferential surface of the frame body 11. As a result, a flow path 23 having a spiral shape through which the refrigerant can flow is formed between the outer circumferential surface of the stator 20 (stator frame 22) and the inner circumferential surface of the frame body 11.

As described above, the flow path 23 is formed by the fitting of the stator frame 22 and the frame body 11. Thus, when the stator frame 22 exists alone, the refrigerant does not flow through the cooling groove 230. In the present embodiment, description of the flowing of the refrigerant through the cooling groove 230 will be made with an assumption that the frame body 11 is fit to the outside of the stator frame 22.

A refrigerant (not shown) for cooling heat transmitted from the iron core 21 flows through the flow path 23. The refrigerant supplied from the supply port 14 of the frame body 11 (frame 10) flows through the outer circumferential surface of the stator frame 22 while turning in a spiral along the flow path 23. The refrigerant flows through the flow path 23 while performing heat exchange with the outer circumferential surface of the stator frame 22 via the cooling groove 230, and is discharged from the discharge port 15 of the frame body 11 to the outside. Note that FIG. 1 is a diagram showing a basic configuration of the motor 1, and therefore, the groove width, the pitch, or the like of the flow path 23 (cooling groove 230) are shown as uniform.

As shown in FIG. 1, the power line 27 electrically connected to the winding 26 is drawn from the iron core 21 of the stator 20. The power line 27 is connected to a power supply installed at the outside of the motor 1 (not shown). During operation of the motor 1, for example, a three-phase alternating current is supplied to the iron core 21, so that a rotary magnetic field for rotating the rotor 30 is formed. The rotor 30 is a part rotated by magnetic interaction between the rotor 30 and the rotary magnetic field formed by the stator 20. The rotor 30 is provided at the inner circumferential side of the stator 20.

The rotary axis 32 is a member supporting the rotor 30. The rotary axis 32 is inserted to penetrate an axis center of the rotor 30, and is fixed to the rotor 30. A pair of bearings 13 are fit to the rotary axis 32. The bearing 13 is a member supporting the rotary 32 in a rotatable manner, and is provided in the frame body 11. The rotary 32 is supported in a rotatable manner around the rotary axis line S by the frame body 11 and the bearings 13. The rotary axis 32 penetrates the axis hole 12, and, for example, is connected to a cutting tool, a power transmission mechanism installed at the outside, a deceleration mechanism, or the like (all of them are not shown).

In the motor 1 shown in FIG. 1, when a three-phase alternating current is supplied to the stator 20 (iron core 21), a rotation force is generated in the rotor 30 due to magnetic interaction between the rotor 30 and the stator 20 in which a rotary magnetic field is formed, and the rotation force is output to the outside via the rotary axis 32.

Next, the cooling groove 230 formed in the stator frame 22 of the first embodiment will be described. FIG. 2 is a conceptual diagram showing a shape of the cooling groove 230 formed in the stator frame 22 of the first embodiment.

The annular grooves 240 are formed along the circumferential direction of the outer circumferential surface at both end portions in the axis direction (X direction) of the stator frame 22. At one end side and another end side in the axis direction, the annular grooves 240 respectively communicate with end portions (an introducing portion and a discharge portion for the refrigerant) of the cooling groove 230, and a also communicate with the supply port 14 and the discharge port 15 of the refrigerant (see FIG. 1). The refrigerant introduced from the annular groove 240 on the one end side in the axis direction (X direction) to the introducing portion of the cooling groove 230 flows through in a spiral along the cooling groove 230 in the outer circumferential surface of the stator frame 22, and then flows from the discharge portion of the cooling groove 230 to the annular groove 240 on the another end side to be discharged to the outside.

As shown in FIG. 2, in the cooling groove 230 formed in the stator 22 of the first embodiment, the groove widths W in between one end side and another end side in the axis direction are all uniform. In the cooling groove 230 formed in the stator frame 22, a groove pitch P1 in regions at one end side and another end side in the axis direction is narrower than a groove pitch P2 in a region at a vicinity of the center in the axis direction (P1<P2). Such a configuration can improve heat dissipation properties in regions at one end side and another end side in the axis direction in the stator frame 22 as described later.

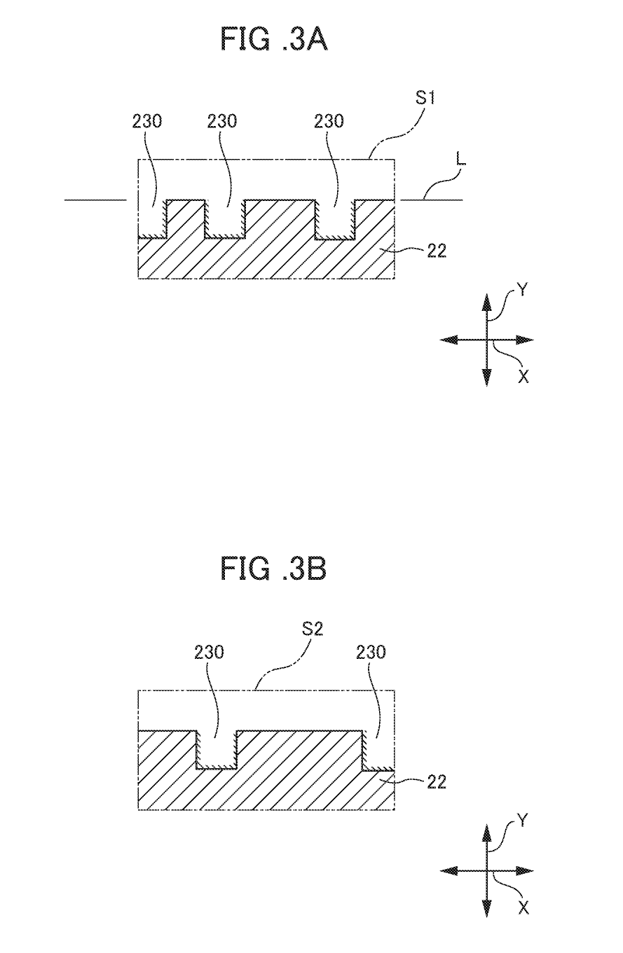

Next, a relationship between a surface length and heat dissipation properties of the cooling groove 230 will be described. FIG. 3A is a cross-sectional view corresponding to a unit section region S1 of FIG. 2. FIG. 3B is a cross-sectional view corresponding to a unit section region S2 of FIG. 2. FIG. 4 is a conceptual diagram showing an end portion in the axis direction of the stator 20. Here, the “unit section region” refers to regions having the same size set for a cross section obtained by cutting the stator frame 22 in a plain surface including the center axis (rotary axis line S) of the stator frame 22. The unit section region S1 shown in FIG. 3A and the unit section region 12 shown in FIG. 3B are regions having the same size.

Note that in FIG. 3A and FIG. 3B, for easy comparison, the unit section region is set to a region including space located outside the radial direction (Y direction) of the stator frame 22. The location of the unit section region is not limited thereto, and may be set with the outside surface (a surface defined by line L of FIG. 3A) of the stator frame 22 as a reference, for example. That is, the size and position of the unit section region may be set in any manner as long as the size relationship of surface lengths of the cooling groove 230 can be compared.

The cooling groove 230 formed in the outer circumferential surface of the stator frame 22 can perform heat exchange of a larger amount with the refrigerant as the surface length per the unit section region is longer. The surface length is a length (length indicated by minute oblique lines) obtained by summing lengths of two side surfaces and a bottom surface of the cooling groove 230. The total area obtained by integrating this surface length along the cooling groove 230 having a spiral shape is an area contributing to heat dissipation (heat exchange). When the total length of the cooling groove 230 is the same, in the cooling groove 230, as the surface length per the unit section region is longer, the heat dissipation properties are more excellent. Note that the surface length per the unit section region is represented by the total sum of the surface length of the cooling groove 230 included in the region.

As described above, in the cooling groove 230 formed in the stator frame 22 of the first embodiment, the groove p itch P1 in the regions at one end side and another end side in the axis direction is narrower than the groove pitch P2 in the region at the vicinity of the center in the axis direction. As a result, in the regions at one end side and another end side in the axis direction, since the array density of the cooling groove 230 is high, as shown in FIG. 3A, the surface length of the cooling groove 230 per the unit section region S1 is long. On the other hand, in the region at the vicinity of the center in the axis direction, the groove pitch P2 is wider (P2>P1). As a result, in the region at the vicinity of the center in the axis direction, since the array density of the cooling groove 230 is low, as shown in FIG. 3B, the surface length of the cooling groove 230 per the unit section region S2 is relatively smaller than that in the regions at one end side and another end side in the axis direction. Note that examples of the regions at one end side and another end side of the cooling groove 230 include a range of 0 to 30% with respect to the total length in the axis direction of the stator frame 22, and examples of the region at the vicinity of the center include a range of 30 to 70%.

During operation of the motor 1, heat is generated in the winding 26 inserted to the iron core 21, in the inside of the stator frame 22. However, as shown in FIG. 4, in the stator 20, the end portion 26a (this is same in the end portion on the opposite side in the N direction) of the winding 26 is not only apart from the iron core 21, but also apart from the cooling groove 230 that is at the endmost in the axis direction of the stator frame 22, so that there is a problem that heat is hard to be dissipated.

Note that, as shown in FIG. 4, in the stator 20, molds 25 formed of a resin are provided at the end portions in the axis direction (X direction) of the iron core 21. However, among the amount of heat generated in the end portion 26a of the winding 26, the amount of heat (thin arrows in the drawing) dissipated from the end surfaces of the molds 25 is only slight. It is also conceived that, by forming the cooling groove 230 in a further end portion (the end portion 26a side of the winding 26) in the axis direction of the stator frame 22, the heat dissipation is improved. However, as shown in FIG. 4, a tap 24 for attaching the stator frame 22 to the frame body 11 (see FIG. 1) is provided in the end portion in the axis direction of the stator frame 22. Thus, the cooling groove 230 cannot be formed in a further end portion in the axis direction of the stator frame 22, and it is difficult to improve the heat dissipation properties.

On the other hand, the stator frame 22 of the first embodiment is configured such that the surface length of the cooling groove 230 per the unit section region S1 at one end side and another end side in the axis direction is longer than the surface length of the cooling groove 230 per the unit section region S2 at the vicinity of the center in the axis direction. Thus, among the amount of heat generated in the end portion 26a of the winding 26, a larger amount of heat (thick arrows in the drawing) can be dissipated to the cooling groove 230 provided at one end side and another end side in the axis direction.

In general, the motor 1 is designed as a whole such that a region having low heat dissipation properties has a protection temperature or lower. Thus, although higher torque can be obtained, since there is limitation in temperature, the performance (mainly, continuous torque) as a motor is suppressed. However, the stator frame 22 of the first embodiment is excellent in the heat dissipation properties in the end portion 26a of the winding 26, as described above. Thus, the motor 1 including the stator frame 22 of the first embodiment can designed such that higher torque can be obtained.

Note that in the regions at one end side and another end side in the axis direction, the stator frame 22 of the first embodiment has a high array density of the cooling groove 230, and therefore there is concern that the flow path (piping path) resistance is large in this region. When the flow path resistance is large, the flow rate per time of the refrigerant cannot be increased, and therefore the heat dissipation properties are impaired. However, with the stator frame 22 of the first embodiment, in the region at the vicinity of the center in the axis direction, since the array density of the cooling groove 230 is low, the flow path resistance is not large as a whole. In the stator frame 22, in the region at the vicinity of the center in the axis direction, since the heat resistance among the winding 26, the iron core 21, and the stator frame 22 is naturally low, even when the groove pitch P2 is set wide, there is hardly any influence to the heat dissipation properties. Accordingly, the stator frame 22 of the first embodiment can have more excellent heat dissipation properties without increasing the flow path resistance.

### SECOND EMBODIMENT

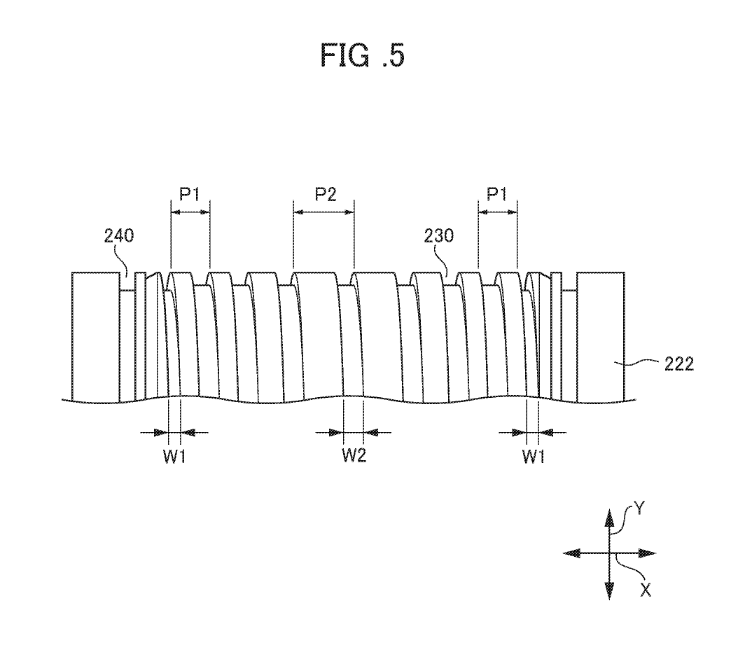

FIG. 5 is a conceptual diagram showing a shape of the cooling groove 230 formed in the stator frame 222 of a second embodiment. The stator frame 222 of the second embodiment is different from the stator frame of the first embodiment in that the groove pitches and the groove widths of the cooling groove 230 are different. Other configurations are the same as those in the first embodiment. Thus, in FIG. 5, only the stator frame 222 of the second embodiment is illustrated, and illustration of the entire motor 1 is omitted. In description and drawings of the second embodiment, members or the like equivalent to those in the first embodiment are added with the same reference numerals as those in the first embodiment or with reference numerals that are the same at the end (lower two digits) thereof as appropriate, and redundant description will be omitted.

As shown in FIG. 5, in the cooling groove 230 formed in the stator frame 222 of the second embodiment, the groove pitch P1 in the regions at one end side and another end side in the axis direction is narrower than the groove pitch P2 in the region at the vicinity of the center in the axis direction (P1<P2). In the cooling groove 230 formed in the stator frame 222, the groove width W1 in the regions at one end side and another end side in the axis direction is narrower than the groove width W2 in the region at the vicinity of the center in the axis direction (W1<W2). In the cooling groove 230 formed in the stator frame 222 of the second embodiment, the ratio of the length of the groove width W1 with respect to the groove width W2 is, for example, about 0.1 to 0.9 when the groove width W2 is set to “1”.

In the cooling groove 230 formed in the stator frame 222 of the second embodiment, in the regions at one end side and another end side in the axis direction, the groove pitch P1 and the groove width W1 are narrower than the groove pitch P2 and the groove width W2 in the region at the vicinity of the center in the axis direction, respectively. Thus, the surface length of the cooling groove 230 per the unit section region (S1) at one end side and another end side in the axis direction is longer than the surface length of the cooling groove 230 per the unit section region (S2) in the vicinity of the center in the axis direction. Accordingly, similar to the stator frame 22 of the first embodiment, the stator frame 222 of the second embodiment can dissipate large amounts of heat among heat generated in the end portion 26a of the winding 26 to the cooling groove 230.

Since the cooling groove 230 formed in the stator frame 222 of the second embodiment has the groove pitch P1 and the groove width W1 both being narrow in the regions at one end side and another end side in the axis direction, the surface length the cooling groove 230 in the regions can be made longer. In the cooling groove 230 formed in the stator frame 222 of the second embodiment, by widening the groove pitch P2 and the groove width W2 in the region at the vicinity of the center in the axis direction, the flow path resistance can be prevented from increasing as a whole. Note that the cooling groove 230 formed in the stator frame 222 of the second embodiment may be configured such that the groove pitch P1 and/or the groove width W1 is/are gradually widened toward the region at the vicinity of the center in the axis direction.

### THIRD EMBODIMENT

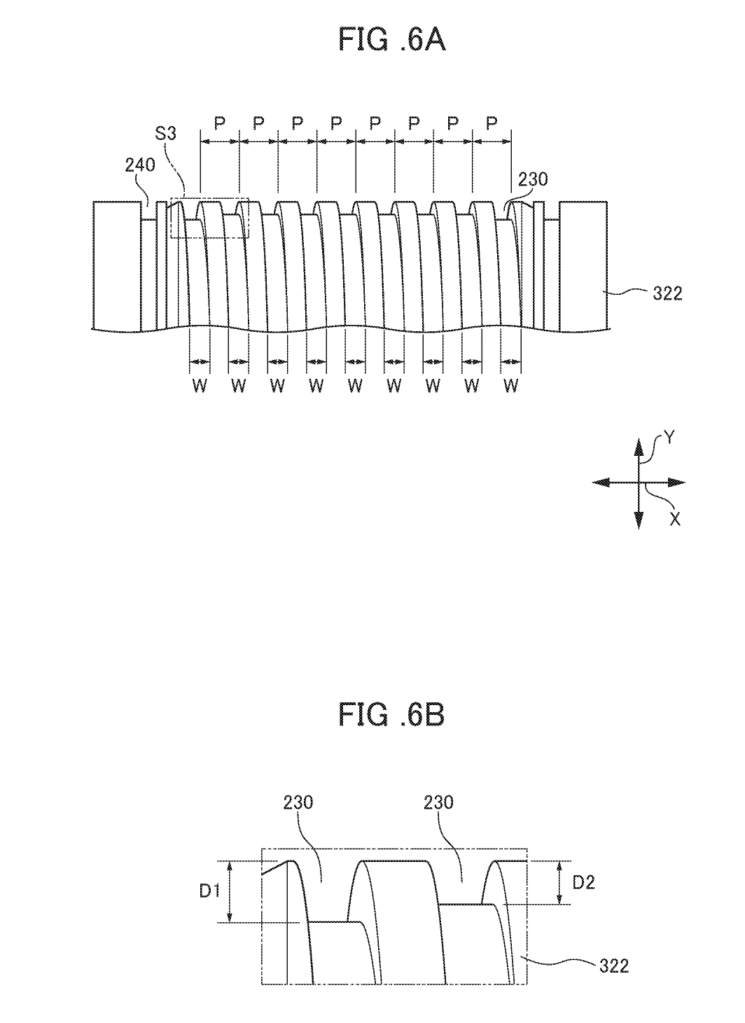

FIG. 6A is a conceptual diagram showing a shape of the cooling groove 230 formed in the stator frame 322 or a third embodiment. FIG. 6B is an enlarged diagram corresponding to a region S3 of FIG. 6A. The stator frame 322 of the third embodiment is different from the stator frame of the first embodiment in that the groove depths of the cooling groove 230 are partially different in the axis direction. Other configurations are the same as those in the first embodiment. Thus, in FIG. 6A, only the stator frame 322 is illustrated, and illustration of the motor 1 as a whole is omitted. In description and drawings of the third embodiment, members or the like equivalent to those in the first embodiment are added with the same reference numerals as those in the first embodiment with reference numerals that are the same at the end (lower two digits) thereof as appropriate, and redundant description will be omitted.

As shown in FIG. 6A, in the cooling groove 230 formed in the stator frame 322 of the third embodiment, the groove pitches P and the groove widths W in between one end side and another end side Jr the axis direction are all uniform. In the cooling groove 230 formed in the stator frame 322, as shown in FIG. 6B, the groove depth D1 in the regions as one end side and another end side in the axis direction is deeper than the groove depth D2 in the region at the vicinity of the center in the axis direction. The ratio of the groove depth D1 with respect to the groove depth D2 is, for example, about 1.1 to 1.5 when the groove depth D2 is set to “1”. Note that, as shown in FIG. 6A, in the present embodiment, the region at the vicinity of the center in the axis direction is set wider than that in the other embodiments.

In the cooling groove 230 formed in the stator frame 322 of the third embodiment, the groove depth D1 in the regions at one end side and another end side in the axis direction is deeper than the groove depth D2 in the region at the vicinity of the center in the axis direction. Thus, the surface length of the cooling groove 230 per the unit section region (S1) at one end side and another end side in the axis direction is longer than the surface length of the cooling groove 230 per the unit section region (S2) at the vicinity of the center in the axis direction. Accordingly, similar to the stator frame 22 of the first embodiment, the stator frame 322 of the third embodiment can dissipate large amounts of heat among heat generated in the end portion 26a of the winding 26 to the cooling groove 230.

In the cooling groove 230 formed in the stator frame 322 or the third embodiment, the groove depth is made deep in the regions at one end side and another end side in the axis direction, so that the surface length is increased. Thus, as shown in FIG. 6A, the groove widths and the groove pitches may be all uniform. The groove width is not limited thereto, and the groove width in the regions at one end side and another end side in the axis direction may narrower than the groove width in the region at the vicinity of the center in the axis direction. In this case, winch the numeric value determined by the flow path length/(groove width*groove depth) is larger than the constant determined by the flow path resistance, by changing the groove pitch in the region in the axis direction to shorten the flow path length, the numeric value can be reduced. Note that when the groove pitch is changed in the region in the axis direction, the groove pitch in the regions at one end side and another end side in the axis direction is to be set narrower than the groove pitch in the region at the vicinity of the center in the axis direction. As a result, the flow path resistance of the cooling groove 230 can be set within an appropriate range.

The embodiments of the present invention have been described above. However, the present invention is not limited to the embodiments described above, and may be variously modified or changed as in the modifications described later, and those are also included in the technical scope of the present invention. The effects described in the embodiments are only a list of the most suitable effects generated by the present invention, and are not limited to those described in the embodiments. Note that the embodiments described above and the modifications described later can be used in combination as appropriate, and detailed description thereof is omitted.

### Modifications

In the embodiments, a case where the cooling groove 230 is a line of a spiral groove has been described. However, the cooling groove 230 is not limited thereto. The cooling groove 230 may be a plurality of lines of spiral grooves, or may be parallel grooves. In the embodiments, an example in which the cooling groove 230 has a concaved groove shape has been described. However, the cooling groove 230 is not limited thereto. The cooling groove 230 may have a groove shape that is a right-triangle in which one side is an inclined surface, or may have a groove shape that is a triangle shape (V shape) in which both sides are inclined surfaces. The cooling groove 230 may have a groove shape that is a trapezoid in which both sides having a bottom side therebetween are inclined surfaces, or may have a groove shape in which a bottom side is a semicircular shape (U shape). In addition to the above, the cooling groove 230 may have any shape as long as the refrigerant can flow through the cooling groove 230 appropriately. In the embodiments an example has been described in which the motor is the rotary electric machine to which the stator frame and the stator according to the present invention can be applied. However, the rotary electric machine is not limited thereto. The rotary electric machine to which the stator frame and the stator according to the present invention can be applied may be a power generator.

### EXPLANATION OF REFERENCE NUMERALS

1: Motor (rotary electric machine), 11: Frame body, 20: Stator, 21: Iron core, 22, 222, 322: Stator frame, 23: Flow path, 26: Winding, 30: Rotor, 230: Cooling groove, D1, D2: Groove depth, P, P1, P2: Groove pitch, S1, S2: Unit section region, W, W1, W2: Groove width

What is claimed is:

1. A stator frame having a substantially cylindrical shape and including a function of cooling a stator of a rotary electric machine,
the stator frame comprising a cooling groove provided along a circumferential direction of an outer circumferential surface in between one end side and another end side in an axis direction as a flow path of a refrigerant in the outer circumferential surface of the stator frame,
wherein, in a section of the stator frame cut in a plain surface including an axis of the stator frame, a surface length of the cooling groove per a unit section region at one end side and another end side in the axis direction is longer than a surface length of the cooling groove per a unit section region at a vicinity of a center in the axis direction.

2. The stator frame according to claim 1, wherein, in the cooling groove in the section of the stator frame, a groove width in between one end side and another end side the axis direction is uniform, and
a groove pitch in regions at one end side and another end side in the axis direction is narrower than a groove pitch in a region at a vicinity of a center in the axis direction.

3. The stator frame according to claim 1, wherein, in the cooling groove in the section of the stator frame, a groove pitch in one end side and another end side in the axis direction is narrower than a groove pitch in a region at a vicinity of a center in the axis direction, and
a groove width in regions at one end side and another end side in the axis direction is narrower than a groove width in a region at a vicinity of a center in the axis direction.

4. The stator frame according to claim 1, wherein, in the cooling groove in the section of the stator frame, a groove depth in regions at one end side and another end side in the axis direction is deeper than a groove depth in a region at a vicinity of a center in the axis direction.

5. A stator comprising the stator frame according to claim 1, and
an iron core having a substantially cylindrical shape and provided at an inner circumferential side of the stator frame.

6. A rotary electric machine comprising the stator according to claim 5, and
a rotor supported by a rotary axis and provided at an inner circumferential side of the stator.
